(19) United States
(12) Patent Application Publication
(10) Pub. No.: US 2014/0098454 A1
(43) Pub. Date: Apr. 10, 2014

(54) MULTILAYERED CERAMIC ELECTRONIC COMPONENT AND METHOD OF MANUFACTURING THE SAME

(71) Applicant: SAMSUNG ELECTRO-MECHANICS CO., LTD., Suwon (KR)

(72) Inventor: Joon Hwan KWAG, Suwon (KR)

(73) Assignee: SAMSUNG ELECTRO-MECHANICS CO., LTD., Suwon (KR)

(21) Appl. No.: 13/786,172

(22) Filed: Mar. 5, 2013

(30) Foreign Application Priority Data
Oct. 10, 2012 (KR) 10-2012-0112607

(51) Int. Cl. H01G 4/30

(52) U.S. Cl. CPC H01G 4/30
USPC 361/301.4; 29/25.42

(57) ABSTRACT

There is provided a multilayered ceramic electronic component including: a ceramic body having first and second main surfaces opposing each other and first and second end surfaces opposing each other and including dielectric layers; internal electrodes disposed to face each other and having the dielectric layer interposed therebetween; and external electrodes electrically connected to the internal electrodes, wherein the external electrodes include first external electrodes formed of nickel (Ni) on portions of the first and second main surfaces while covering the entirety of the first and second end surfaces of the ceramic body; and second external electrodes formed of copper (Cu) on outer surfaces of the first external electrodes.

### CROSS-REFERENCE TO RELATED APPLICATIONS

This application claims the priority of Korean Patent Application No. 10-2012-0112607 filed on Oct. 10, 2012, in the Korean Intellectual Property Office, the disclosure of which is incorporated herein by reference.

### BACKGROUND OF THE INVENTION

1. Field of the Invention

The present invention relates to a high capacitance multilayered ceramic electronic component capable of suppressing infiltration of a plating solution into an internal electrode so as to have excellent reliability, even in the case in which a thickness of external electrodes is reduced.

2. Description of the Related Art

In general, in accordance with the recent trend for the miniaturization of electronic products, demand for a multilayered ceramic electronic component having a small size and large capacitance has increased.

Therefore, a dielectric layer and an internal electrode have been thinned and multilayered through various methods. Recently, as a thickness of the dielectric layer has been reduced, multilayered ceramic electronic components having a large number of stacked layers have been manufactured.

In addition, as the thickness of external electrodes also has been required to be reduced, a plating solution may infiltrate into an inner portion of a chip through the external electrodes having a reduced thickness, and thus, there may be technical difficulties in implementing miniaturization.

Particularly, in the case in which the external electrodes have a non-uniform shape, a risk that the plating solution may infiltrate through a portion of external electrodes having a reduced thickness is further increased, such that reliability thereof may not be secured.

Therefore, in the case in which a high capacitance product has a small size, securing reliability thereof is important.

Generally, in order to prevent the plating solution from infiltrating through external electrodes, a method of forming the same level of relatively thin external electrodes on a product in which an external electrode is already formed and firing of the electrode is completed, and then, of plating a corner part has been used. However, in this case, a thickness of the external electrode may be relatively increased.

Therefore, in order to secure reliability of the product simultaneously with preventing the plating solution from infiltrating through external electrodes, the external electrode should be formed to be thin using nickel (Ni).

### RELATED ART DOCUMENT

Japanese Patent Laid-Open Publication No. 2010-267687

Japanese Patent Laid-Open Publication No. 1995-057959

### SUMMARY OF THE INVENTION

An aspect of the present invention provides a high capacitance multilayered ceramic electronic component capable of suppressing infiltration of a plating solution into an internal electrode so as to have excellent reliability, even in the case in which a thickness of an external electrode is reduced.

According to an aspect of the present invention, there is provided a multilayered ceramic electronic component including: a ceramic body having first and second main surfaces opposing each other and first and second end surfaces opposing each other and including dielectric layers; internal electrodes disposed to face each other and having the dielectric layer interposed therebetween; and external electrodes electrically connected to the internal electrodes, wherein the external electrodes include first external electrodes formed of nickel (Ni) on portions of the first and second main surfaces while covering the entirety of the first and second end surfaces of the ceramic body; and second external electrodes formed of copper (Cu) on outer surfaces of the first external electrodes.

The first external electrodes may have a thickness of 0.5 to 5 μm.

The internal electrodes and the first external electrodes may be formed of the same material.

The first external electrodes may have a nickel (Ni) content of 60% or less by weight based on the total weight thereof.

The second external electrodes may have a copper (Cu) content of 60% or less by weight based on the total weight thereof.

The number of multilayered dielectric layers may be 100 to 1000.

The ceramic may be barium titanate (BaTiO₃).

According to another aspect of the present invention, there is provided a method of manufacturing a multilayered electronic component, the method including: preparing a ceramic green sheet having first and second main surfaces opposing each other and first and second end surfaces opposing each other and including a dielectric layer; forming an internal electrode pattern on the ceramic green sheet by using a conductive paste for an internal electrode containing nickel (Ni) powder and ceramic powder; stacking and sintering the green sheet including the internal electrode pattern formed thereon to form a ceramic body including internal electrodes disposed therein facing each other, having the dielectric layer interposed therebetween; forming first external electrodes formed of nickel (Ni) on portions of the first and second main surfaces while covering the entirety of the first and second end surfaces of the ceramic body as well as exposed portions of the first and second internal electrodes; and preparing a conductive paste for second external electrodes containing copper and applying the conductive paste to outer surfaces of the first external electrodes to form the second external electrodes.

The first external electrodes may have a thickness of 0.5 to 5 μm.

The internal electrodes and the first external electrodes may be formed of the same material.

The first external electrodes may have a nickel (Ni) content of 60% or less by weight based on the total weight thereof.

The second external electrodes may have a copper (Cu) content of 60% or less by weight based on the total weight thereof.

The number of multilayered dielectric layers maybe 100 to 1000.

The ceramic may be barium titanate (BaTiO₃).

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a multilayered ceramic capacitor according to an embodiment of the present invention;

FIG. 2 is a cross-sectional view taken along line A-A′ of FIG. 1;

FIGS. 3A and 3B are graphs showing equivalent series resistance (ESR) characteristics of external electrodes according to the embodiment of the present invention; and

FIG. 4 is a view showing a manufacturing process of a multilayered ceramic capacitor according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In addition, unless explicitly described otherwise, “comprising” any components will be understood to imply the inclusion of other components but not the exclusion of any other components.

In the drawings, the shapes and dimensions of elements may be exaggerated for clarity, and the same reference numerals will be used throughout to designate the same or like elements.

According to an embodiment of the present invention, a multilayered ceramic electronic component is provided. An example of the multilayered ceramic electronic component according to the embodiment of the present invention may include a multilayered ceramic capacitor, an inductor, a piezoelectric element, a varistor, a chip resistor, a thermistor, and the like. Hereinafter, a multilayered ceramic capacitor will be described as an example of the multilayered ceramic electronic component.

Hereinafter, embodiments of the present invention will be described in detail with reference to the accompanying drawings.

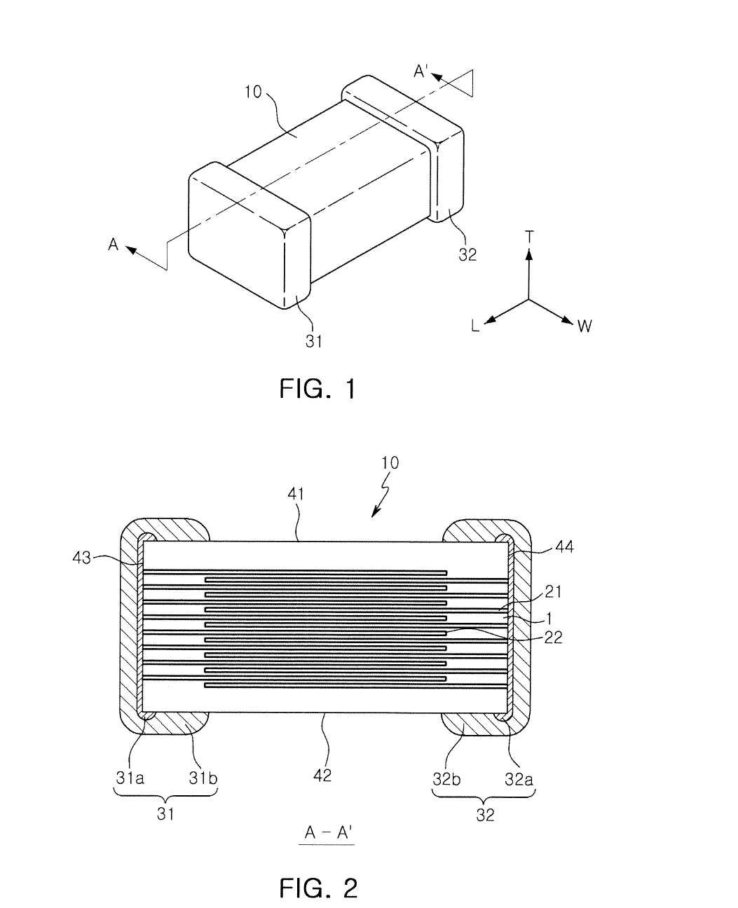

FIG. 1 is a perspective view schematically showing a multilayered ceramic capacitor according to an embodiment of the present invention.

FIG. 2 is a cross-sectional view taken along line A-A′ of FIG. 1.

Referring to FIGS. 1 and 2, the multilayered ceramic electronic component according to the embodiment of the present invention may include a ceramic body 10 having first and second main surfaces 41 and 42 opposing each other and first and second end surfaces 43 and 44 opposing each other and including dielectric layers 1; internal electrodes 21 and 22 disposed to face each other, having the dielectric layer 1 interposed therebetween; and external electrodes 31 and 32 electrically connected to the internal electrodes 21 and 22, wherein the external electrodes 31 and 32 include first external electrodes 31a and 32a formed of nickel (Ni) on portions of the first and second main surfaces 41 and 42 while covering the entirety of the first and second end surfaces 43 and 44 of the ceramic body 10; and second external electrodes 31b and 32b formed of copper (Cu) on outer surfaces of the first external electrodes 31a and 32a.

One ends of the respective internal electrodes 21 and 22 may be alternately exposed to the end surfaces in a length direction of the ceramic body.

The first external electrodes 31a and 32a may have a nickel (Ni) content of 60% or less by weight based on the total weight thereof.

In addition, the second external electrodes 31b and 32b may have a copper (Cu) content of 60% or less by weight based on the total weight thereof.

Hereinafter, the multilayered ceramic electronic component according to the embodiment of the present invention will be described. Particularly, a multilayered ceramic capacitor will be described. However, the present invention is not limited thereto.

The ceramic body 10 may have a rectangular parallelepiped shape, but is not limited thereto. In addition, the ceramic body 10 may have the first and second main surfaces 41 and 42 opposing each other and the first and second end surfaces 43 and 44 opposing each other as shown in FIG. 2. A method of preparing the chip shaped ceramic body 10 is not particularly limited, but the ceramic body 10 may be prepared by a general method of manufacturing a ceramic multilayer body.

Meanwhile, in the multilayered ceramic capacitor according to the embodiment of the present invention, a ‘length direction’ refers to an ‘L’ direction of FIG. 1, a ‘width direction’ refers to a ‘W’ direction of FIG. 1, and a ‘thickness direction’ refers to a ‘T’ direction of FIG. 1. Here, the ‘thickness direction’ is the same as a direction in which dielectric layers are stacked, that is, the ‘stacking direction’.

According to the embodiment of the present invention, a raw material forming the dielectric layer 1 is not particularly limited, as long as sufficient capacitance may be obtained therefrom, but may be, for example, a barium titanate (BaTiO₃) powder.

In a material forming the dielectric layer 1, various ceramic additives, organic solvents, plasticizers, binders, dispersing agents, and the like, may be mixed with a powder such as a barium titanate (BaTiO₃) powder, or the like, according to a purpose of the present invention.

A material forming the internal electrodes 21 and 22 is not particularly limited, but may be a conductive paste formed of at least one of, for example, silver (Ag), lead (Pg), platinum (Pt), nickel (Ni), and copper (Cu). However, in the embodiment of the present invention, the internal electrode may be formed of a conductive material containing nickel (Ni), the same material as that of the first external electrodes 31a and 32a.

The multilayered ceramic capacitor according to the embodiment of the present invention may include the external electrodes 31 and 32 electrically connected to the respective internal electrodes 21 and 22.

The external electrodes 31 and 32 may be electrically connected to the internal electrodes 21 and 22 in order to form capacitance.

According to the embodiment of the present invention, the external electrodes 31 and 32 may include the first external electrodes 31a and 32a formed of nickel (Ni) on portions of the first and second main surfaces 41 and 42 while covering the entirety of first and second end surfaces 43 and 44 of the ceramic body 10, and the second external electrodes 31b and 32b formed of copper (Cu) on the outer surfaces of the first external electrodes 31a and 32a.

The first external electrodes 31a and 32a formed of nickel (Ni), the same material as that of the internal electrodes 21 and 22, may prevent infiltration of a plating solution, such that a high capacitance multilayered ceramic electronic component having improved moisture resistance characteristics, capable of preventing product degradation, may be implemented.

Further, generally, in order to implement an ultra compact and high capacitance multilayered ceramic capacitor, a thickness of the external electrodes has gradually been reduced. The first external electrodes 31a and 32a need to have a thickness of 0.5 μm or more in order to protect the internal electrodes 21 and 22 when a physical or chemical impact is applied thereto, and have a thickness of 5 μm or less in order to prevent the capacitor from becoming excessively thick.

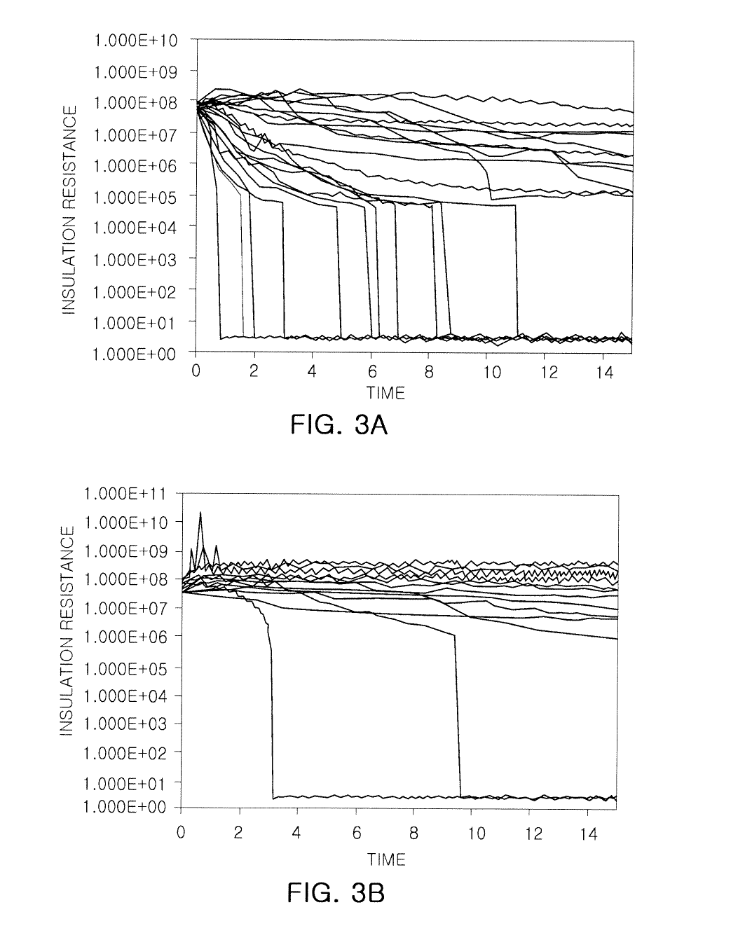

FIGS. 3A and 3B are graphs showing equivalent series resistance (ESR) characteristics of external electrodes according to the embodiment of the present invention.

FIG. 3A is a graph showing ESR characteristics at a voltage of 10 volts for 15 hours in the case in which the external electrodes 31 and 32 are only formed of copper (Cu), and FIG. 3B is a graph showing ESR characteristics under the same conditions as in FIG. 3A in the case in which the first external electrodes 31a and 32a are formed of nickel (Ni) and the second external electrodes 31b and 32b are formed of copper (Cu).

Comparing FIGS. 3A and 3B with each other, it could be appreciated that a value of insulation resistance is reduced as time goes by in FIG. 3A, but since the value of the insulation resistance is almost maintained over time in FIG. 3B, ESR characteristics are improved.

The reason is as follows: in the case of FIG. 3B, the first external electrodes 31a and 32a are formed of nickel, the same material as that of the internal electrodes 21 and 22, on end surfaces of the ceramic body to which the internal electrodes 21 and 22 are exposed, to prevent the plating solution from infiltrating into a weak portion of the external electrodes 31 and 32 at the time of plating, such that degradation is prevented and moisture resistance characteristics are improved, and the first external electrodes 31a and 32a are sintered together with the ceramic body 10, such that since connectivity between the internal electrodes 21 and 22 and the external electrodes 31 and 32 is improved and thus contact properties are improved, as compared to the case in which the external electrodes 31 and 32 are only formed of copper (Cu), thereby improving the ESR characteristics.

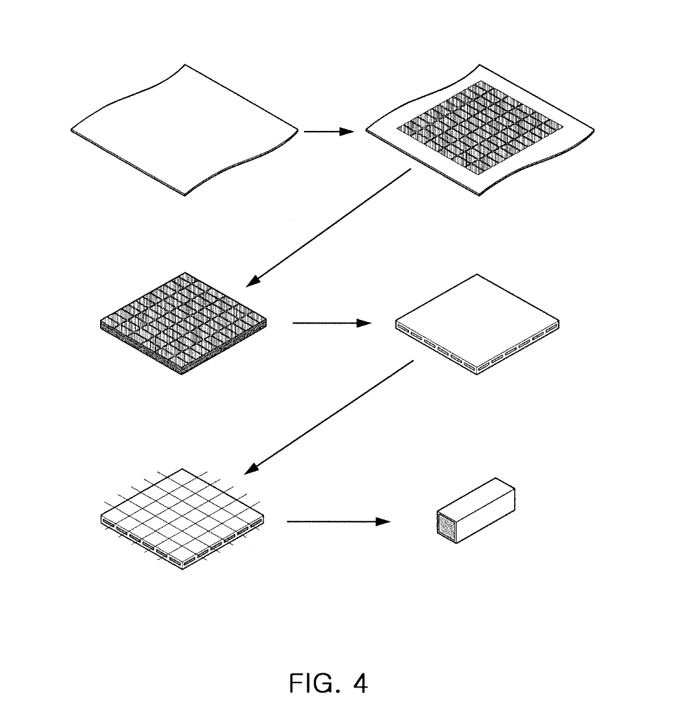

FIG. 4 is a view showing a manufacturing process of a multilayered ceramic capacitor according to another embodiment of the present invention.

Referring to FIG. 4, a method of manufacturing a multilayered ceramic electronic component according to another embodiment of the present invention may include: preparing a ceramic green sheet having first and second main surfaces 41 and 42 opposing each other and first and second end surfaces 43 and 44 opposing each other and including a dielectric layer 1; forming an internal electrode pattern on the ceramic green sheet by using a conductive paste for an internal electrode containing nickel (Ni) powder and ceramic powder; stacking and sintering the green sheet including the internal electrode pattern formed thereon to form a ceramic body 10 including internal electrodes 21 and 22 disposed therein facing each other, having the dielectric layer 1 interposed therebetween; forming first external electrodes 31a and 32a formed of nickel (Ni) on portions of the first and second main surfaces 41 and 42 while covering the entirety of the first and second end surfaces 43 and 44 of the ceramic body 10 as well as exposed portions of the first and second internal electrodes 21 and 22; and preparing a conductive paste for second external electrodes containing copper and applying the conductive paste to outer surfaces of the first external electrodes to form second external electrodes 31b and 32b.

Hereinafter, the method of manufacturing the multilayered ceramic electronic component according to another embodiment of the present invention will be described. Particularly, a method of manufacturing a multilayered ceramic capacitor will be described, but the present invention is not limited thereto.

In addition, descriptions of features overlapped with those of the multilayered ceramic electronic component according to the embodiment of the present invention described above will hereinafter be omitted.

The multilayered ceramic capacitor according to the present embodiment may be prepared as follows.

First, slurry containing a powder such as a barium titanate (BaTiO₃) powder, or the like, is applied to a carrier film and dried thereon to prepare a plurality of ceramic green sheets, thereby forming a dielectric layer 1.

The plurality of ceramic green sheets may be set to have thicknesses such that an average thickness of the dielectric layers 1 after firing is 1.0 μm.

Next, a conductive paste for an internal electrode containing metal particles having an average particle size of 0.05 to 0.2 μm may be prepared, and the average particle size of the metal particle may be variously applied according to a thickness of the internal electrodes 21 and 22.

The metal is not particularly limited, but may be, for example, at least one of silver (Ag), lead (Pg), platinum (Pt), nickel (Ni), and copper (Cu). However, according to the embodiment of the present invention, nickel may be used similarly to the first external electrodes 31a and 32a.

After the conductive paste for an internal electrode is applied to the green sheet by a screen printing method to form the internal electrodes 21 and 22, a multi-layer body may be prepared by stacking the green sheets.

In this case, according to the embodiment of the present invention, the first external electrodes 31a and 32a including nickel (Ni), the same material as that of the internal electrodes 21 and 22, may be formed on portions of the first and second main surfaces 41 and 42 while covering the entirety of the first and second end surfaces 43 and 44 of the ceramic body 10 as well as the exposed portions of the first and second internal electrodes 21 and 22 in the green chip state.

Then, the multilayer body is compressed and cut to form a chip having a 1005 standard size (length×width×thickness is 1.0 mm×0.5 mm×0.5 mm), and the chip is fired at a temperature of 1050 to 1200° C. under a reducing atmosphere in which H2 is 0.1% or less, such that the ceramic body 10 may be prepared.

That is, in this case, according to the embodiment of the present invention, instead of forming the external electrodes 31 and 32 on a product in which sintering of ceramic body 10 is completed; the first external electrodes 31a and 32a including nickel (Ni), the same material as that of the internal electrodes 21 and 22, may be thinly formed on portions of the first and second main surfaces 41 and 42 while covering the entirety of the first and second end surfaces 43 and 44 of the ceramic body 10 as well as the exposed portions of the first and second internal electrodes 21 and 22, with the same material as that of the internal electrodes 21 and 22, in the green chip state, that is, before sintering of the ceramic body 10, and then sintering may be performed on the formed external electrodes together with the ceramic body 10.

Next, the conductive paste for second external electrodes containing copper (Cu) may be prepared and applied to the outer surfaces of the first external electrodes 31a and 32a so as to be electrically connected to the internal electrodes, such that the second external electrodes 31b and 32b may be formed.

The second external electrodes 31b and 32b may be prepared by dipping both end portions of the ceramic body 10 into the conductive paste for a second external electrode, but are not limited thereto. For example, the second external electrodes may be manufactured by various methods.

In addition, the second external electrodes 31b and 32b may have a copper (Cu) content of 60% or less by weight based on the total weight thereof.

Then, in order to mount the multilayered ceramic capacitor on a printed circuit board (PCB), the second external electrodes 31b and 32b containing copper (Cu) maybe formed on the outer surfaces of the first external electrodes 31a and 32a, thereby preventing a plating solution infiltrated through weak portions of the external electrodes 31 and 32 from infiltrating into the internal electrodes 21 and 22.

The multilayered ceramic electronic component manufactured by a method of manufacturing a multilayered ceramic electronic component according to the embodiment of the present invention may suppress the plating solution from infiltrating into the internal electrodes 21 and 22, thereby having the excellent reliability even in the case in which the external electrodes 31 and 32 are thinned.

That is, as described above, the first external electrodes 31a and 32a are relatively thinly formed on portions of the first and second main surfaces 41 and 42 while covering the entirety of the first and second end surfaces 43 and 44 of the ceramic body 10 as well as the exposed portions of the first and second internal electrodes 21 and 22 with the same material as that of the internal electrodes 21 and 22 in the green chip state, that is, before sintering of the ceramic body 10, and then sintering is performed on the formed external electrodes together with the ceramic body 10. Then, the second external electrodes 31b and 32b are formed on the outer surfaces of the first external electrodes 31a and 32a so that the plating solution infiltrated through weak portions of the first external electrodes 31a and 32a is not infiltrated into the internal electrodes 21 and 22, such that the high capacitance multilayered ceramic electronic component having excellent reliability even in the case in which the external electrodes 31 and 32 are thinned may be implemented.

In addition, according to the related art, at the time of developing a high capacitance product, in order to significantly increase the number of multilayered internal electrodes 21 and 22 for securing capacitance, a design for reducing thicknesses of upper and lower covers of a ceramic body 10 and a margin portion has been generally used. This design is effective in view of implementation of high capacitance, but since the internal electrodes 21 and 22 are formed on outer surfaces that become relatively thin at the time of forming external electrodes 31 and 32, the internal electrodes 21 and 22 may be relatively easily exposed when a physical or chemical impact is applied thereto from the outside.

In addition, in the case in which an applied thickness of corner parts of the external electrodes 31 and 32 formed on the upper and lower cover and the margin parts of the ceramic body 10 is reduced, the corner part may be relatively thinly formed or disconnected due to sintering shrinkage generated during a process of sintering the external electrodes 31 and 32.

Therefore, in the case of external electrodes 31 and 32 used in high capacitance products, a material that may be sintered at a relatively low temperature is used in order to reduce thermal impact at the time of sintering the external electrodes 31 and 32, and particularly, in the case in which glass that is softened at a relatively low temperature is used, the external electrodes have relatively weak acid resistance at the time of plating. However, these properties may facilitate infiltration of the plating solution, and the plating solution may be mainly infiltrated through these weak portions, at the time of plating. In addition, these properties may affect moisture resistance and be a main cause of product quality deterioration.

Therefore, in order to prevent infiltration of the plating solution, a method of thinly re-forming external electrodes at the same level on a product in which external electrodes 31 and 32 are already formed and firing of the electrodes are completed to supplement the corner part has been used, but in this case, the thickness of the external electrodes may be relatively increased.

Therefore, although the thickness of the external electrodes 31 and 32 may be thin in embodiments of the present invention, the first external electrodes 31a and 32a may have a thickness of 0.5 μm or more in order to protect the internal electrodes 21 and 22 when a physical or chemical impact is applied thereto from the outside, and may have a thickness of 5 μm or less in order to prevent the capacitor from becoming excessively thick.

In a method of manufacturing a ceramic electronic component according to another embodiment of the present invention, a description overlapped with the description of the multilayered ceramic electronic component according to the embodiment of the present invention described above is omitted.

As set forth above, according to the embodiments of present invention, a high capacitance multilayered ceramic electronic component capable of suppressing infiltration of a plating solution into an internal electrode to have excellent reliability even in the case in which a thickness of external electrodes is reduced may be implemented.

While the present invention has been shown and described in connection with the embodiments, it will be apparent to those skilled in the art that modifications and variations can be made without departing from the spirit and scope of the invention as defined by the appended claims.

What is claimed is:

1. A multilayered ceramic electronic component comprising:
a ceramic body having first and second main surfaces opposing each other and first and second end surfaces opposing each other and including dielectric layers;
internal electrodes disposed to face each other and having the dielectric layer interposed therebetween; and
external electrodes electrically connected to the internal electrodes,
the external electrodes including first external electrodes formed of nickel (Ni) on portions of the first and second main surfaces while covering the entirety of the first and second end surfaces of the ceramic body; and second external electrodes formed of copper (Cu) on outer surfaces of the first external electrodes.

2. The multilayered ceramic electronic component of claim 1, wherein the first external electrodes have a thickness of 0.5 to 5 μm.

3. The multilayered ceramic electronic component of claim 1, wherein the internal electrodes and the first external electrodes are formed of the same material.

4. The multilayered ceramic electronic component of claim 1, wherein the first external electrodes have a nickel (Ni) content of 60% or less by weight based on the total weight thereof.

5. The multilayered ceramic electronic component of claim 1, wherein the second external electrodes have a copper (Cu) content of 60% or less by weight based on the total weight thereof.

6. The multilayered ceramic electronic component of claim 1, wherein the number of multilayered dielectric layers is 100 to 1000.

7. The multilayered ceramic electronic component of claim 1, wherein the ceramic is barium titanate (BaTiO₃).

8. A method of manufacturing a multilayered electronic component, comprising:
preparing a ceramic green sheet having first and second main surfaces opposing each other and first and second end surfaces opposing each other and including a dielectric layer;
forming an internal electrode pattern on the ceramic green sheet by using a conductive paste for an internal electrode containing nickel (Ni) powder and ceramic powder;
stacking and sintering the green sheet including the internal electrode pattern formed thereon to forma ceramic body including internal electrodes disposed therein facing each other, having the dielectric layer interposed therebetween;
forming first external electrodes formed of nickel (Ni) on portions of the first and second main surfaces while covering the entirety of the first and second end surfaces of the ceramic body as well as exposed portions of the first and second internal electrodes; and
preparing a conductive paste for second external electrodes containing copper and applying the conductive paste to outer surfaces of the first external electrodes to form the second external electrodes.

9. The method of manufacturing a multilayered electronic component of claim 8, wherein the first external electrodes have a thickness of 0.5 to 5 μm.

10. The method of manufacturing a multilayered electronic component of claim 8, wherein the internal electrodes and the first external electrodes are formed of the same material.

11. The method of manufacturing a multilayered electronic component of claim 8, wherein the first external electrodes have a nickel (Ni) content of 60% or less by weight based on the total weight thereof.

12. The method of manufacturing a multilayered electronic component of claim 8, wherein the second external electrodes have a copper (Cu) content of 60% or less by weight based on the total weight thereof.

13. The method of manufacturing a multilayered electronic component of claim 8, wherein the number of multilayered dielectric layers is 100 to 1000.

14. The method of manufacturing a multilayered electronic component of claim 8, wherein the ceramic is barium titanate (BaTiO₃).
